(19) United States
(12) Patent Application Publication
(10) Pub. No.: US 2013/0091997 A1
(43) Pub. Date: Apr. 18, 2013

(54) PUNCH DEVICE

(71) Applicants: YOU-LONG TANG, Shenzhen City (CN); CHENG-FENG SUN, Shenzhen City (CN); DONG-PING ZHANG, Shenzhen City (CN); GUANG YANG, Shenzhen City (CN)

(72) Inventors: YOU-LONG TANG, Shenzhen City (CN); CHENG-FENG SUN, Shenzhen City (CN); DONG-PING ZHANG, Shenzhen City (CN); GUANG YANG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/451,789

(22) Filed: Apr. 20, 2012

(30) Foreign Application Priority Data
Oct. 14, 2011 (CN) 201110311578.5

(51) Int. Cl. B26D 7/32; B21D 45/02

(52) U.S. Cl. 83/109

(57) ABSTRACT

A punch device includes a mounting platform, a punch mechanism, a feeding mechanism, and a positioning and ejecting mechanism. The punch mechanism is mounted over the mounting platform for punching a pre-punched workpiece positioned on the mounting platform. The feeding mechanism is mounted on the mounting platform for conveying the pre-punched workpiece. The positioning and ejecting mechanism is mounted on the mounting platform and positioned under the punch mechanism, for positioning the pre-punched workpiece during a punching process, and ejecting the punched workpiece after the punching process is performed, thereby facilitating an operator to take away the punched workpiece.

### BACKGROUND

1. Technical Field

The present disclosure generally relates to a punch device or punch press.

2. Description of Related Art

Punch devices or presses are well known in the prior art for forming and cutting metal work pieces. A commonly used punch press or device generally comprises a die set. The die set includes a male punch and a female die. At the beginning of the punching process, the male punch is temporarily affixed to the end of a ram to move in a vertically linear manner The female die is positioned in a table or work bed. A work piece is positioned between the male punch and the female die. To initiate the punching sequence, the ram is moved downward, causing the male punch to enter the work piece and push it through the female die. This creates a desired hole or deformity in the work piece at a pre-determined and specified site, which usually is at the center of the work piece.

However, after the punching process, the punched work pieces are often difficult to be taken or removed from the conveyer belt manually. It often requires significant amount of time to take away the punched work pieces, thereby causing low efficiency using the existing punch device or press.

Therefore, there is room for improvement within the art.

### BRIEF DESCRIPTION OF THE DRAWINGS

The components in the drawings are not necessarily drawn to scale, the emphasis instead being placed upon clearly illustrating the principles of the present disclosure.

FIG. 1 shows an assembled isometric view of an embodiment of a punch device.

FIG. 2 shows a partial, exploded isometric view of the punch device of FIG. 1.

FIG. 3 shows a side view of the punch device of FIG. 1, wherein the punch device is in a state of use.

### DETAILED DESCRIPTION

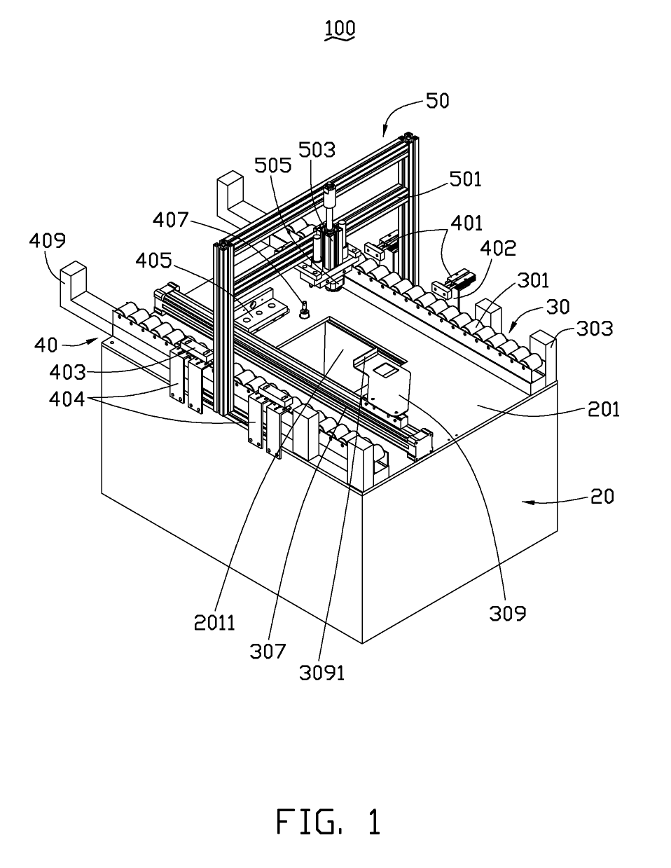

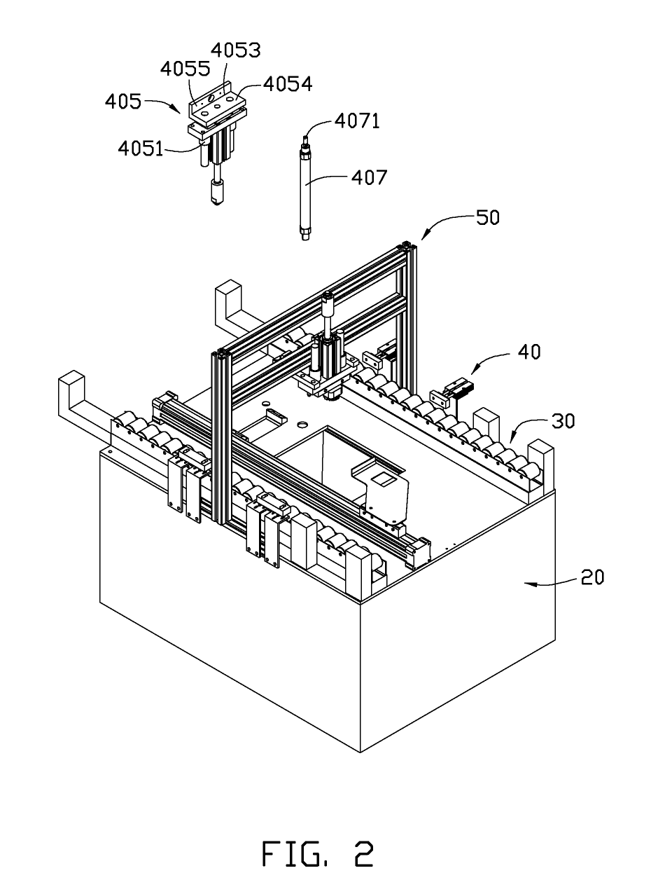

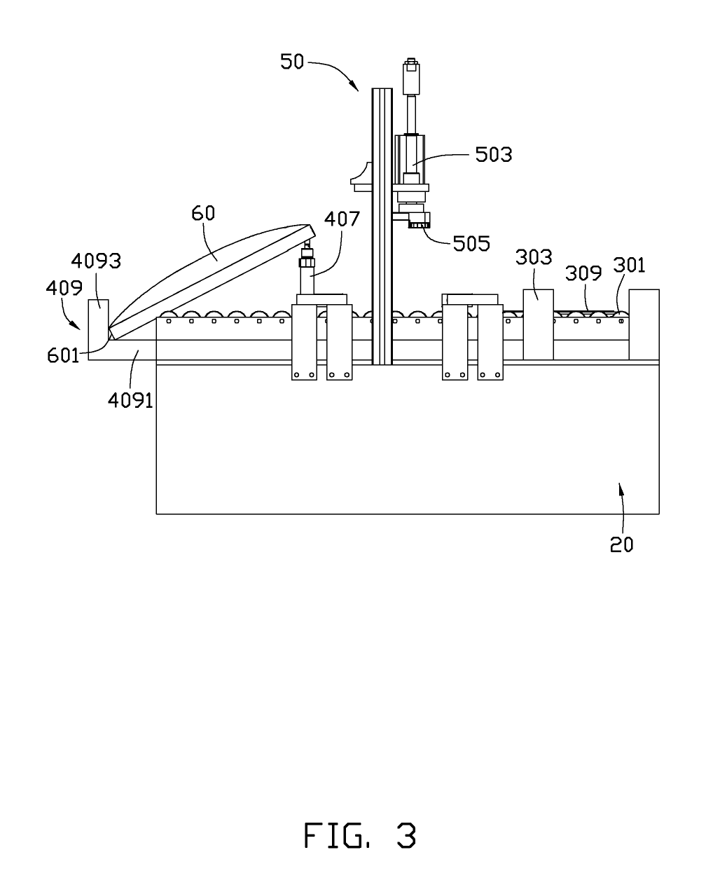

FIGS. 1 through 3 show an embodiment of a punch device 100. The punch device 100 includes a mounting platform 20, a feeding mechanism 30, a positioning and ejecting mechanism 40, and a punch mechanism 50. The punch mechanism 50 is mounted over the mounting platform 20 and is driven to move in a vertically linear manner, for punching a pre-punched workpiece 60 (the workpiece that is shown in FIG. 3 is one punched workpiece). The feeding mechanism 30 is mounted on the mounting platform 20, for conveying the pre-punched workpiece 60. The positioning and ejecting mechanism 40 is mounted on the mounting platform 20 and positioned adjacent to a specified position under the punch mechanism 50. The positioning and ejecting mechanism 40 positions the pre-punched workpiece 60 during a punching process, and ejects the punched workpiece 60 after the punching process, thereby facilitating an operator to take away the punched workpiece 60.

The mounting platform 20 includes a mounting plate 201 and defines a material dropping hole 2011 through a substantially central portion of the mounting plate 201. The material dropping hole 2011 is positioned under the punch mechanism 50 for facilitating the scrap slug material punched from the workpiece 60 to be taken away.

The feeding mechanism 30 includes two conveyer assemblies 301, four guiding members 303, a linear driving cylinder 307, and a feeding arm 309. The two conveyer assemblies 301 are oppositely mounted on the mounting plate 201 and parallely positioned adjacent to two sides of the mounting plate 201, for conveying the pre-punched workpieces 60. In the illustrated embodiment, each conveyer assembly 301 includes a plurality of rollers rotatably mounted on one side of the mounting plate 201, and positioned adjacent to each other in that order along a longitudinal direction of the mounting plate 201. The four guiding members 303 are oppositely mounted at two outsides at one end of the two conveyer assemblies 301, for facilitating the pre-punched workpieces 60 to be placed on the two conveyer assemblies 301 quickly and precisely. The linear driving cylinder 307 is mounted on the mounting plate 201 and positioned between and parallel to the two conveyer assemblies 301. The feeding arm 309 is slidably mounted to the linear driving cylinder 307 for feeding the pre-punched workpieces 60, together with the two conveyer assemblies 301. The feeding arm 309 is driven by the linear driving cylinder 307 to slide along a longitudinal direction parallel to the two conveyer assemblies 301 and the linear driving cylinder 307. The feeding arm 309 includes a pushing portion 3091 extending and deforming from a distal end thereof.

The positioning and ejecting mechanism 40 includes two positioning cylinders 401, two positioning members 403, a blocking assembly 405, an ejecting cylinder 407 and two stopping members 409. The two positioning cylinders 401 are separately mounted to a substantially middle portion of one side of the mounting platform 20 via two first positioning brackets 402. The two positioning members 403 are separately mounted to a substantially middle portion of the other side of the mounting platform 20 via two second positioning brackets 404, and positioned opposite to the corresponding two positioning cylinders 401. The number of the positioning cylinders 401 and the number of the positioning members 403 are not limited to two, and that they depend on the corresponding embodiment. In one embodiment, there are one positioning cylinder 401 and one positioning member 403. The positioning cylinder 401 and the positioning member 403 are directly fixed on two sides of the mounting platform 20. The positioning member 403 may also be integrally formed with the mounting platform 20.

The blocking assembly 405 includes a blocking cylinder 4051 and a blocking plate 4053. The blocking cylinder 4051 is mounted on a middle portion of one end of the mounting plate 201, away from the guiding member 303 and positioned adjacent to the corresponding material dropping hole 2011. The blocking plate 4053 is assembled to the blocking cylinder 4051 and is driven by the blocking cylinder 4051 to move along a direction perpendicular to the mounting plate 201, thereby blocking the pre-punched workpiece 60. In the illustrated embodiment, the blocking plate 4053 is a substantially L-shaped plate, and includes a fixing portion 4054 fixed to the blocking cylinder 4051 and a blocking portion 4055 perpendicularly extends from one side of the fixing portion 4054.

The ejecting cylinder 407 is mounted on the mounting plate 201 together with the blocking assembly 405, and positioned between the blocking assembly 405 and the material dropping hole 2011. The ejecting cylinder 407 includes an ejection member 4071 assembled to a distal end thereof, away from the mounting plate 201. The ejection member 4071 is driven by the ejecting cylinder 407 to move along a direction perpendicular to the mounting plate 201, for ejecting the punched workpiece 60 upward after the punching process.

The two stopping members 409 are mounted to the opposite two sides of the distal end of the mounting platform 20, away from the guiding member 303, and respectively connected with the corresponding distal ends of the two conveyer assemblies 301. Each stopping member 409 is substantially L-shaped, and includes a connecting portion 4091 and a stopping portion 4093 extending from a distal end of the connecting portion 4091. The connecting portion 4091 is fixed with the end surface of the mounting platform 20.

The punch mechanism 50 is mounted over the mounting platform 20 and includes a fastening bracket 501, a punching driver 503 and a punching head 505. The fastening bracket 501 is mounted on the mounting platform 20 and positioned over the material dropping hole 2011 of the mounting plate 201. The punching driver 503 is assembled to the fastening bracket 501 together with the punching head 505. The punching head 505 is driven by the punching driver 503 to move in a vertically linear manner, for punching the pre-punched workpiece 60 positioned there-under. In the illustrated embodiment, the punching driver 503 is a punching cylinder.

FIG. 3 shows the punch device 100 in use, the pre-punched workpiece 60 is placed on the two conveyer assemblies 301 and positioned above the mounting plate 201 and between the guiding members 303. The pushing portion 3091 of the feeding arm 309 resists against one side surface 601 of the pre-punched workpiece 60. The feeding arm 309 is driven by the linear driving cylinder 307 to slide toward the punch mechanism 50, meanwhile, the corresponding pre-punched workpiece 60 is pushed by the feeding arm 309 and conveyed to a preset punching position under the punch mechanism 50, by the two conveyer assemblies 301. The pre-punched workpiece 60 is finally positioned above the material dropping hole 2011 of the mounting plate 201. The blocking plate 4053 is driven by the blocking cylinder 4051 to move upward and resists against the corresponding pre-punched workpiece 60. The two positioning cylinders 401 and the two positioning members 403 oppositely mounted to be resisted against two sides of the pre-punched workpiece 60. Thus, the pre-punched workpiece 60 is firmly positioned under the punch mechanism 50 by the feed arm 309, the blocking assembly 405, the two positioning cylinders 401 and the two positioning members 403 cooperatively.

After that, the punching head 505 is driven by the punching driver 503 to move downwards, thereby punching the pre-punched workpiece 60. After the punching process is performed, the blocking plate 4053 is driven by the blocking cylinder 4051 to move downwards away from the punched workpiece 60. The feeding arm 309 is driven by the linear driving cylinder 307 to slide toward the distal end of the mounting platform 20 thereby pushing against the punched workpiece 60 till the punched workpiece 60, resisting against the stopping portions of the two stopping members 409, is positioned at the distal end of the mounting platform 20. The ejection member 4071 is driven by the ejecting cylinder 407 to move upward, thereby ejecting one end of the punched workpieces 60 upward to be tilted at a proper angle (such as 45 degrees) with respect to the mounting plate 201, thereby facilitating the operator to take away or remove the punched workpiece 60. Finally, the feeding arm 309 is driven by the linear driving cylinder 307 to slide back to its original position for conveying another pre-punched workpiece 60 that is next in order, together with the two conveyer assemblies 301.

The punch device 100 has a simple structure with high efficiency. Since the stopping member 409 together with the ejecting cylinder 407 is formed at a distal end of the mounting platform 20, the punched workpiece 60 can be ejected upward to be tilted at an angle with respect to the mounting platform 20, such that after the punching process, the operator can take away the punched workpiece 60 quickly and conveniently. In addition, as in use, the pre-punched workpiece 60 can be conveyed to the punch mechanism 50 quickly by means of the linear driving cylinder 307 and the conveyer assemblies 301, thus the efficiency of the punch device 100 is greatly enhanced.

In one embodiment, the number of the conveyer assemblies 301 is not limited to two, and it may also be only one or more than two. The stopping member 409 may be omitted or may be integrally formed with the mounting platform 20.

Finally, while various embodiments have been described and illustrated, the disclosure is not to be construed as being limited thereto. Various modifications can be made to the embodiments by those skilled in the art without departing from the true spirit and scope of the disclosure as defined by the appended claims.

What is claimed is:

1. A punch device, comprising:
a mounting platform;
a punch mechanism mounted over the mounting platform for punching a pre-punched workpiece positioned on the mounting platform;
a feeding mechanism mounted on the mounting platform for conveying the pre-punched workpiece; and
a positioning and ejecting mechanism mounted on the mounting platform and positioned under the punch mechanism, the positioning and ejecting mechanism being capable of positioning the pre-punched workpiece during a punching process, and ejecting the punched workpiece after the punching process.

2. The punch device of claim 1, wherein the positioning and ejecting mechanism comprises at least one positioning cylinder, at least one positioning member, and an ejecting cylinder, the at least one positioning cylinder and the at least one positioning member are oppositely mounted at two sides of the mounting platform for cooperatively positioning the pre-punched workpiece; the ejecting cylinder is mounted on the mounting platform and positioned away from the feeding mechanism, for ejecting the punched workpiece upwardly after the punching process, to be tilted at a proper angle with respect to the mounting platform.

3. The punch device of claim 2, wherein the mounting platform comprises a mounting plate and defines a material dropping hole through the mounting plate, the punch mechanism is mounted over the material dropping hole of the mounting plate; the ejecting cylinder is positioned adjacent to the material dropping hole.

4. The punch device of claim 3, wherein the positioning and ejecting mechanism further comprises a blocking assembly mounted on the mounting plate, and positioned adjacent to the ejecting cylinder and the material dropping hole; the blocking assembly comprises a blocking cylinder and a blocking plate assembled to the blocking cylinder, the blocking plate is capable of being driven by the blocking cylinder to move along a direction perpendicular to the mounting plate, for blocking the pre-punched workpiece.

5. The punch device of claim 4, wherein the blocking plate comprises a fixing portion fixed to the blocking cylinder and a blocking portion extending from one side of the fixing portion.

6. The punch device of claim 3, wherein the positioning and ejecting mechanism further comprises at least one stopping member mounted to a distal end of the mounting platform, away from the feeding mechanism.

7. The punch device of claim 3, wherein the punch mechanism comprises a fastening bracket, a punching driver and a punching head, the fastening bracket is mounted on the mounting platform and positioned over the material dropping hole of the mounting plate;
the punching driver is assembled to the fastening bracket together with the punching head, and the punching head is driven by the punching driver to move in a vertically linear manner, for punching the pre-punched workpiece.

8. The punch device of claim 3, wherein the feeding mechanism comprises a conveyer assembly, the conveyer assembly mounted on the mounting plate and positioned adjacent to one side of the mounting plate, for conveying the pre-punched workpieces, the conveyer assembly comprises a plurality of rollers rotatably mounted on the mounting plate and positioned adjacent to each other in that order along a longitudinal direction of the mounting plate.

9. The punch device of claim 7, wherein the punching driver is a punching cylinder.

10. The punch device of claim 8, wherein, the feeding mechanism further comprises two guiding members oppositely mounted at two sides of one end of the mounting platform, for facilitating the pre-punched workpieces being placed on the conveyer assembly.

11. The punch device of claim 10, wherein, the feeding mechanism further comprises a linear driving cylinder and a feeding arm, the linear driving cylinder is mounted on the mounting plate and positioned adjacent to the two guiding members and parallel to the conveyer assembly; the feeding arm is slidably mounted to the linear driving cylinder for feeding the pre-punched workpieces, together with the conveyer assembly.

12. A punch device, comprising:
a mounting platform defining a material dropping hole;
a punch mechanism mounted over the material dropping hole of the mounting platform for punching a pre-punched workpiece positioned on the mounting platform;
a feeding mechanism mounted on the mounting platform for conveying the pre-punched workpiece;
a positioning and ejecting mechanism mounted on the mounting platform and positioned adjacent to the material dropping hole, the positioning and ejecting mechanism being capable of positioning the pre-punched workpiece during a punching process, and ejecting the punched workpiece after the punching process;
wherein, the positioning and ejecting mechanism comprises at least one positioning cylinder, at least one positioning member, and an ejecting cylinder, the at least one positioning cylinder and the at least one positioning member are oppositely mounted at two sides of the mounting platform, the ejecting cylinder is mounted on the mounting platform and positioned adjacent to the material dropping hole, away from the feeding mechanism.

13. The punch device of claim 12, wherein the feeding mechanism comprises two conveyer assemblies, a linear driving cylinder and a feeding arm, the two conveyer assemblies are oppositely mounted on two sides of the mounting platform, each conveyer assembly comprises a plurality of rollers rotatably mounted on the mounting plate and positioned adjacent to each other in that order along a longitudinal direction of the mounting plate; the linear driving cylinder is mounted on the mounting plate and positioned parallely between the two conveyer assemblies; the feeding arm is slidably mounted to the linear driving cylinder for feeding the pre-punched workpieces, together with the two conveyer assemblies.

14. The punch device of claim 13, wherein the positioning and ejecting mechanism further comprises a blocking assembly mounted on the mounting plate, and positioned adjacent to the ejecting cylinder and the material dropping hole; the blocking assembly comprises a blocking cylinder and a blocking plate assembled to the blocking cylinder, the blocking plate is capable of being driven by the blocking cylinder to move along a direction perpendicular to the mounting plate, for blocking the pre-punched workpiece.

15. The punch device of claim 14, wherein the positioning and ejecting mechanism further comprises at least one stopping member mounted to a distal end of the mounting platform, away from the feeding mechanism.

16. The punch device of claim 14, wherein the punch mechanism comprises a fastening bracket, a punching driver and a punching head, the fastening bracket is mounted on the mounting platform and positioned over the material dropping hole of the mounting platform; the punching driver is assembled to the fastening bracket together with the punching head, the punching head is driven by the punching driver to move in a vertically linear manner, for punching the pre-punched workpiece.
